(19) United States
(12) Patent Application Publication
(10) Pub. No.: US 2026/0347073 A1
(43) Pub. Date: Nov. 5, 2026

(54) A WRAP

(71) Applicant: TAMA GROUP, Kibbutz Mishmar Haemek (IL)

(72) Inventors: Uri BLICH, Kibbutz Mishmar Haemek (IL); Rotem EITAN, Kibbutz Mishmar Haemek (IL); Yoav BRAVERMAN, Moshav Moledet (IL)

(73) Assignee: TAMA GROUP, Kibbutz Mishmar Haemek (IL)

(21) Appl. No.: 19/484,240

(22) PCT Filed: May 16, 2024
(86) PCT No.: PCT/IL2024/050476

§ 371 Date: Nov. 13, 2025

Related U.S. Application Data
(60) Provisional application No. 63/467,351, filed on May 18, 2023.
(60) Provisional application No. 63/532,926, filed on Aug. 16, 2023.

(51) Int. Cl. B65D 71/06; D03D 9/00; D03D 15/60

(52) U.S. Cl. CPC B65D 71/063; D03D 9/00; D03D 15/60; D10B 2505/10

(57) ABSTRACT

A wrap including a plurality of transverse bands, intersecting a plurality of longitudinal bands, the plurality of longitudinal bands each comprising two intermittently adhered films forming channels at discontinuities of adhesion between the films, and wherein at least one intersection of the longitudinal and transverse band/s at least one transverse band is threaded through at least one of the channels of at least one longitudinal band.

### CROSS REFERENCE TO RELATED APPLICATIONS

This application claims the benefit of priority from U.S. Provisional Patent Application Nos. 63/467,351, titled “WRAP”, filed on May 18, 2023 and 63/532,926, titled “WRAP”, filed on Aug. 16, 2023. The contents of both applications are incorporated herein by reference in their entirety.

### FIELD OF THE INVENTION

The present invention, in some embodiments thereof, relates to a wrap and, more particularly, but not exclusively, to a recyclable net-wrap.

### BACKGROUND

Currently, hay bales are wrapped mainly with knitted net-wrap and sometimes twines. The structure of the net, including the size of the holes, the width of the threads and their strength and elongation allow the net to grip to the crop so that it can be transported.

This grip allows for quick and efficient wrapping without the need for a special closure. It also enables efficient transportation of the bales and their storage. The holes allow crop ventilation thus preventing development of mold.

On the other hand, these same characteristics do not allow recycling of net-wrap, because the crop that clings to the net falls with the net (over 50% organic material stay with the net after removal). So far, no effective industrial solution for cleaning and recycling the nets has been found.

Plastic pollution, including round cropped bales wrapping nets, has become a critical global issue with impacts on the environment, wildlife and human health. The problem with netting plastic wrap for hay bales is that they contain over 50 percent organic material (crop). It is almost impossible to separate the plastic and therefore its recycling is not a viable economical process.

### SUMMARY

The following embodiments and aspects thereof are described and illustrated in conjunction with systems, tools and methods which are meant to be exemplary and illustrative, not limiting in scope.

In accordance with an aspect some embodiments, there is provided net, comprising: a plurality of transverse band/s; intersecting a plurality of longitudinal bands; wherein the net is a rectangular having a length of at least 100 times longer than the net's width; wherein each longitudinal band of the plurality of longitudinal bands comprises two intermittently adhered films forming channels at discontinuities of adhesion between films; wherein at an intersection of a longitudinal band and a transverse band a transverse band is threaded through a channel in longitudinal band.

In one embodiment, it is provided that the net's length is from 1800 meters to 6000 meters or from 2500 meters to 4200 meters.

In one embodiment, it is provided that the net's width is 60 to 300 cm. In one embodiment, it is provided that the net's width is 60 to 150 cm. In one embodiment, it is provided that the net's width is 100 to 150 cm. In one embodiment, it is provided that the net's width is 110 to 120 cm. In one embodiment, it is provided that the net's width is 112 to 118 cm. In one embodiment, it is provided that the net's width is 112 to 120 cm. In one embodiment, it is provided that the net's width is 112 to 124 cm. In one embodiment, it is provided that the net's width is 115 to 125 cm.

In one embodiment, it is provided that each film of the two intermittently adhered films has a different width. In one embodiment, it is provided that the longitudinal band comprises sticky edges.

In one embodiment, it is provided that each square having a surface area from 80 square cm to 1 square meter within net is characterized by a weight/weight ratio of total longitudinal bands weight to total transverse band/s weight of 2:1 to 200:1. In one embodiment, it is provided that the net is characterized by a weight/weight ratio of total longitudinal bands weight to total transverse band/s weight of 2:1 to 200:1.

In one embodiment, it is provided that the net is characterized by a length/length ratio of total longitudinal bands length to total transverse band/s length of 3:1 to 1:3.

In one embodiment, it is provided that the net is characterized by 6 to 60 longitudinal bands. In one embodiment, it is provided that the net is characterized by 6 to 12 longitudinal bands. In one embodiment, it is provided that the net is characterized by 10 to 16 longitudinal bands.

In one embodiment, it is provided that the transverse band is 7 to 150 μm thick. In one embodiment, it is provided that the width of the transverse band is 0.5 to 20 mm. In one embodiment, it is provided that the width of the transverse band is 2 to 40 mm.

In one embodiment, it is provided that the longitudinal band is 20 to 350 μm thick. In one embodiment, it is provided that the longitudinal band is 40 to 120 μm thick. In one embodiment, it is provided that the longitudinal band is 60 to 80 μm thick.

In one embodiment, it is provided that the width of the longitudinal band is 5 to 405 mm. In one embodiment, it is provided that the width of the longitudinal band is 5 to 10 mm.

In one embodiment, it is provided that the net comprises 6 to 60 longitudinal bands per 0.6 to 2.7 m width of the net. In one embodiment, it is provided that the net comprises 5 to 12 longitudinal bands per 1 m width of net. In one embodiment, it is provided that the net comprises 10 to 16 longitudinal bands per 1 to 1.2 m width of the net.

In one embodiment, it is provided that at least one channel of the channels is configured to impede movement of the transverse band through the channel.

According to some embodiments, the adhesion within at least one channel of the channels includes: a semi-adhered zone, non-adhered, a friction zone or a combination thereof between the films. In some embodiments, at least two of a plurality of transverse band/s are threaded through channels of at least two of a plurality of the longitudinal bands and forming four intersections between the longitudinal bands and the transverse band/s. In some embodiments, the channel includes inner surfaces facing each other and wherein the transverse band occupies 3% to 30% of a surface area of the inner surfaces. In some embodiments, the ratio between a surface area of adhered portions of the films to a surface area of the films at the channel is at least 3:1.

In some embodiments, a position and/or orientation of the transverse band in relation to the longitudinal band at the channel is adjustable. In some embodiments, a location of the point of intersection between the longitudinal band and the transverse band is adjustable along the length of at least one of the longitudinal bands and/or the transverse band/s. In some embodiments, adjustability of the net is independent of the elasticity of the transverse band/s and the longitudinal bands. In some embodiments, the transverse band further crosses an edge longitudinal band in a serpentine or zigzag manner. In some embodiments, the transverse band crosses the edge longitudinal band of the net and forms a semi-loop at one net's longitudinal edge, another net's longitudinal edge, or both. In some embodiments, the semi-loop extends beyond the one net's longitudinal edge, another net's longitudinal edge, or both. In some embodiments, the length (L) of the semi-loop corresponds to a predetermined distance (D) between the intersection of the semi-loop and the edge longitudinal band, at one net's longitudinal edge, another net's longitudinal edge, or both (see FIG. 3). In some embodiments, two adjacent segments of the transverse band threaded through at least one edge longitudinal band and define between them a semi-loop locking portion of the longitudinal band's edge. In some embodiments, the ratio between an area (a) of locking portion exclusive of the channels and an area (b) inclusive of the channels is expressed by (0.1b≥a).

According to some embodiments, provided herein is a net, comprising: a plurality of longitudinal bands; intersecting, at least one transverse band, wherein each longitudinal band of plurality of longitudinal bands comprises two intermittently adhered films forming channels at discontinuities of adhesion between the films; and wherein at an intersection of a longitudinal band and the transverse band, the transverse band is threaded through at least one channel in the longitudinal band, wherein the transverse band crosses at least a portion of plurality of longitudinal bands in a serpentine or zigzag manner. the transverse band crosses the edge longitudinal band of the net and forms a semi-loop at one net's longitudinal edge, another net's longitudinal edge, or both. In some embodiments, the semi-loops extend beyond one net's longitudinal edge, another net's longitudinal edge, or both. In some embodiments, the length (L) of the semi-loop corresponds to a predetermined distance (D) between the intersection of the semi-loop and at least one longitudinal band at one net's longitudinal edge, another net's longitudinal edge, or both. In some embodiments, two adjacent segments of the transverse band threaded through the edge longitudinal band, define between them the semi-loop locking portion of longitudinal band (FIG. 3).

In one embodiment, provided herein a bale comprising the net, wherein the length of the net is 5 to 50 m. In one embodiment, provided herein a bale comprising the net, wherein the length of the net is 10 to 80 m. In one embodiment, provided herein a bale comprising the net, wherein the length of the net is 20 to 60 m. In one embodiment, provided herein a bale comprising the net, wherein the length of the net is 10 to 40 m. In one embodiment, provided herein a bale comprising the net, wherein the length of the net is 25 to 40 m. In one embodiment, provided herein a bale comprising the net, wherein the length of the net is 38 to 38 m.

In one embodiment, provided herein a method of wrapping a bale, comprising wrapping the bale with the net, wherein the bale comprises a crop.

In one embodiment, the method promotes recycling of used net. In one embodiment, the method minimizes crop waste upon unwrapping net.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a perspective view simplified illustration of an embodiment of a net in accordance with some embodiments of the present invention.

FIGS. 2A-2B are cross section view simplified illustrations of embodiments of intersections within a net in accordance with some embodiments of the present invention.

FIGS. 3A-3E are cross sections of illustrations of embodiments of intersections within a net in accordance with some embodiments of the present invention.

FIGS. 4A-4B provide simplified illustrations of the net's tensioning system in accordance with some embodiments of the current invention.

FIG. 5 is a perspective view simplified illustration of an embodiment of a net in accordance with some embodiments of the present invention.

### DETAILED DESCRIPTION

According to some embodiments of the present invention there is provided a wrap in the form of or having a structure of a net. According to some embodiments of the present invention there is provided a net which comprises adjustable intersections 114. In some embodiments, the net comprises a plurality of transverse band/s and a plurality of longitudinal bands. In some embodiments, each longitudinal band comprises two intermittently adhered films. In some embodiments, the adhered segments of the intermittently adhered films are non-reversibly adhered. In some embodiments, the non-adhered portions of the films form channels between the films. In some embodiments, the transverse band is threaded through the channels. In some embodiments, the non-adhered portions of the films impede the movement of the transverse band threaded therethrough. In some embodiments, the dimensions and physical properties of the channel and/or the transverse band determine the adjustability i.e., geometric deformation, of the transverse band within the channels.

In one embodiment, the net is a rectangular net. In one embodiment, the rectangular net has a length which is at least 50 times longer than the net's width. In one embodiment, the rectangular net has a length which is at least 100 times longer than the net's width. In one embodiment, the rectangular net has a length which is at least 200 times longer than the net's width. In one embodiment, the rectangular net has a length which is at least 250 times longer than the net's width. In one embodiment, the rectangular net has a length which is at least 300 times longer than the net's width. In one embodiment, the rectangular net has a length which is at least 500 times longer than the net's width. In one embodiment, the rectangular net has a length which is at least 600 times longer than the net's width. In one embodiment, the rectangular net has a length which is at least 700 times longer than the net's width. In one embodiment, the rectangular net has a length which is at least 800 times longer than the net's width. In one embodiment, the rectangular net has a length which is at least 900 times longer than the net's width. In one embodiment, the rectangular net has a length which is at least 1000 times longer than the net's width. In one embodiment, the rectangular net has a length which is at least 1200 times longer than the net's width. In one embodiment, the rectangular net has a length which is at least 1400 times longer than the net's width. In one embodiment, the rectangular net has a length which is at least 1500 times longer than the net's width. In one embodiment, the rectangular net has a length which is at least 1750 times longer than the net's width. In one embodiment, the rectangular net has a length which is at least 1900 times longer than the net's width. In one embodiment, the rectangular net has a length which is at least 2000 times longer than the net's width. In one embodiment, the rectangular net has a length which is at least 2300 times longer than the net's width. In one embodiment, the rectangular net has a length which is at least 2500 times longer than the net's width. In one embodiment, the rectangular net has a length which is at least 2750 times longer than the net's width. In one embodiment, the rectangular net has a length which is at least 3000 times longer than the net's width. In one embodiment, the rectangular net has a length which is at least 3200 times longer than the net's width. In one embodiment, the rectangular net has a length which is at least 3500 times longer than the net's width. In one embodiment, the rectangular net has a length which is at least 4000 times longer than the net's width.

In one embodiment, the rectangular net has a length which is 50 to 8000 times longer than the net's width. In one embodiment, the rectangular net has a length which is 1000 to 6000 times longer than the net's width. In one embodiment, the rectangular net has a length which is 1000 to 5000 times longer than the net's width. In one embodiment, the rectangular net has a length which is 1200 to 8000 times longer than the net's width. In one embodiment, the rectangular net has a length which is 1200 to 5000 times longer than the net's width. In one embodiment, the rectangular net has a length which is 1500 to 4000 times longer than the net's width. In one embodiment, the rectangular net has a length which is 1800 to 5000 times longer than the net's width. In one embodiment, the rectangular net has a length which is 1500 to 3500 times longer than the net's width. In one embodiment, the rectangular net has a length which is 2000 to 4000 times longer than the net's width. In one embodiment, the rectangular net has a length which is 2000 to 6000 times longer than the net's width. In one embodiment, the rectangular net has a length which is 2500 to 5000 times longer than the net's width.

In one embodiment, the rectangular net is 500 to 8000 meters long. In one embodiment, the rectangular net is 1000 to 8000 meters long. In one embodiment, the rectangular net 1200 to 7000 meters long. In one embodiment, the rectangular net is 1500 to 6000 meters long. In one embodiment, the rectangular net is 1800 to 6000 meters long. In one embodiment, the rectangular net is 2000 to 8000 meters long. In one embodiment, the rectangular net is 2000 to 5000 meters long. In one embodiment, the rectangular net is 2500 to 5000 meters long. In one embodiment, the rectangular net is 3000 to 4000 meters long. In one embodiment, the rectangular net is 3200 to 3800 meters long.

In one embodiment, the width of the net is 40 to 500 cm long. In one embodiment, the width of the net is 60 to 300 cm long. In one embodiment, the width of the net is 80 to 180 cm long. In one embodiment, the width of the net is 60 to 180 cm long. In one embodiment, the width of the net is 90 to 150 cm long. In one embodiment, the width of the net is 100 to 120 cm long. In one embodiment, the width of the net is 110 to 120 cm long. In one embodiment, the width of the net is 60 to 150 cm long. In one embodiment, the width of the net is 60 to 100 cm long. In one embodiment, the width of the net is 90 to 150 cm long. In one embodiment, the width of the net is 90 to 120 cm long. In one embodiment, the width of the net is 100 to 115 cm long. In one embodiment, the width of the net is 90 to 150 cm long. In one embodiment, the width of the net is 120 to 180 cm long. In one embodiment, the width of the net is 120 to 150 cm long. In one embodiment, the width of the net is 130 to 140 cm long.

According to an aspect of some embodiments of the present invention there is provided a net comprising longitudinal bands and transverse band/s wherein the longitudinal bands comprise channels wherein the transverse band/s are threaded through the channels. In some embodiments, the channels are at least partially adhered to the transverse band/s that are threaded therethrough. In some embodiments, the adhesion (weaker adhesion of intersecting bands) between the transverse band and the films at the channel also referred to as junction, intersection or crossing is at least 30% weaker than the adhesion between the films at the adhered portion. In some embodiments, the adhesion between the transverse band and the films at the channel also referred to as junction, intersection or crossing reversal-adhesion. In some embodiments, the adhesion of the longitudinal bands to the transverse band/s is formed at least in part by one or more bonding (e.g., heat bonding, adhesive bonding, gluing or similar), welding, chemical adhesion or any combination thereof. In some embodiments, the adhesion (strong adhesion of intersecting bands) of a longitudinal band's edge to a transverse band is formed by heat bonding, welding, chemical adhesion or any combination thereof, this adhesion at the edge of a longitudinal band is at least twice, 3 times, 4 times, 5 times, 6 times, 8 times or 10 times, stronger than the adhesion at the junction. In one embodiment, longitudinal band's edge is 0.01 to 5 cm long at an end of longitudinal band. In some embodiments, strong adhesion of intersecting bands is performed only in a longitudinal band situated or located at a longitudinal edge of the net.

In one embodiment, it is provided that the longitudinal band comprises sticky edge or edges. In one embodiment, each film of the two intermittently adhered films has a different width. In one embodiment, each film of the two intermittently adhered or partially adhered films has a different width. In one embodiment, a longitudinal band comprises at least one edge, a margin, or an end. In one embodiment, an edge, a margin, or an end is positioned along the film's width. In one embodiment, an edge, a margin, or an end is continuous along the film's width. In one embodiment, an edge, a margin, or an end is discontinuous along the film's width. In one embodiment, a longitudinal band comprises at least one sticky edge, margin, or end. In one embodiment, a sticky edge, a margin, or an end comprises an adherent, a resin, a glue, or the like. In one embodiment, a sticky edge, a margin, or an end is an exposed surface, wherein this surface comprises an adherent, a resin, a glue, or the like.

In one embodiment, a net as described herein or a net segment of 1 meter length and full width is characterized by a weight/weight ratio of total longitudinal bands weight to total transverse band/s weight of 1:1 to 200:1. In one embodiment, a net as described herein or a net segment of 1 meter length and full width is characterized by a weight/weight ratio of total longitudinal bands weight to total transverse band/s weight of 2:1 to 100:1. In one embodiment, a net as described herein or a net segment of 1 meter length and full width is characterized by a weight/weight ratio of total longitudinal bands weight to total transverse band/s weight of 5:1 to 80:1. In one embodiment, a net as described herein or a net segment of 1 meter length and full width is characterized by a weight/weight ratio of total longitudinal bands weight to total transverse band/s weight of 10:1 to 100:1. In one embodiment, a net as described herein or a net segment of 1 meter length and full width is characterized by a weight/weight ratio of total longitudinal bands weight to total transverse band/s weight of 5:1 to 80:1. In one embodiment, a net as described herein or a net segment of 1 meter length and full width is characterized by a weight/weight ratio of total longitudinal bands weight to total transverse band/s weight of 5:1 to 50:1. In one embodiment, a net as described herein or a net segment of 1 meter length and full width is characterized by a weight/weight ratio of total longitudinal bands weight to total transverse band/s weight of 10:1 to 100:1. In one embodiment, a net as described herein or a net segment of 1 meter length and full width is characterized by a weight/weight ratio of total longitudinal bands weight to total transverse band/s weight of 10:1 to 50:1. In one embodiment, a net as described herein or a net segment of 1 meter length and full width is characterized by a weight/weight ratio of total longitudinal bands weight to total transverse band/s weight of 20:1 to 80:1. In one embodiment, a net as described herein or a net segment of 1 meter length and full width is characterized by a weight/weight ratio of total longitudinal bands weight to total transverse band/s weight of 40:1 to 80:1. In one embodiment, a net as described herein or a net segment of 1 meter length and full width is characterized by a weight/weight ratio of total longitudinal bands weight to total transverse band/s weight of 20:1 to 60:1. In one embodiment, a net as described herein or a net segment of 1 meter length and full width is characterized by a weight/weight ratio of total longitudinal bands weight to total transverse band/s weight of 10:1 to 70:1. In one embodiment, a net as described herein or a net segment of 1 meter length and full width is characterized by a weight/weight ratio of total longitudinal bands weight to total transverse band/s weight of 10:1 to 30:1.

In one embodiment, the ratio between a longitudinal band's width to its thickness is 20:1 to 500:1. In one embodiment, the ratio between a longitudinal band's width to its thickness is 20:1 to 200:1. In one embodiment, the ratio between a longitudinal band's width to its thickness is 40:1 to 150:1. In one embodiment, the ratio between a longitudinal band's width to its thickness is 60:1 to 140:1. In one embodiment, the ratio between a longitudinal band's width to its thickness is 80:1 to 120:1. In one embodiment, the ratio between a longitudinal band's width to its thickness is 50:1 to 65:1. In one embodiment, the ratio between a longitudinal band's width to its thickness is 54:1 to 60:1.

In one embodiment, the ratio between a longitudinal band's width to its thickness is important to the net's usability within the baling process. In one embodiment, the ratio between a longitudinal band's width to its thickness is important to the net's usability within the baler. In one embodiment, the ratio between a longitudinal band's width to its thickness is important to the net's usability within the agricultural baler. In one embodiment, the ratio between a longitudinal band's width to its thickness is important to the net's usability within the net's feeder (or feeding system) of the agricultural baler or the agricultural round baler.

In one embodiment, the ratio between the transverse band's width to its thickness is 20:1 to 500:1. In one embodiment, the ratio between the transverse band's width to its thickness is 50:1 to 150:1. In one embodiment, the ratio between the transverse band's width to its thickness is 80:1 to 150:1. In one embodiment, the ratio between the transverse band's width to its thickness is 80:1 to 120:1. In one embodiment, the ratio between the transverse band's width to its thickness is 80:1 to 120:1. In one embodiment, the ratio between the transverse band's width to its thickness is 90:1 to 115:1. In one embodiment, the ratio between the transverse band's width to its thickness is 95:1 to 105:1.

In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 1:1 to 200:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 2:1 to 100:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 5:1 to 80:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 10:1 to 100:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 5:1 to 80:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 5:1 to 50:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal band weight to total transverse band weight of 10:1 to 100:1. In one embodiment, in the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 10:1 to 50:1. In one embodiment, the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 20:1 to 80:1. In one embodiment, the net as described herein, at least one square having a surface area from 80 square cm to 1 square meter or every square having a surface area from 80 square cm to 1 square meter, within the net as described herein, is characterized by a weight/weight ratio of total longitudinal bands weight to total transverse band/s weight of 10:1 to 30:1.

In one embodiment, in the net as described herein the weight/weight ratio of longitudinal bands weight to transverse band/s weight is: 1:4-1:40. In one embodiment, in the net as described herein the weight/weight ratio of longitudinal bands weight to transverse band/s weight is: 1:5-1:25. In one embodiment, in the net as described herein the weight/weight ratio of longitudinal bands weight to transverse band/s weight is: 1:8-1:12.

In one embodiment, in the net as described herein the weight/weight ratio of longitudinal bands weight to transverse band/s weight is: 4:1-40:1. In one embodiment, in the net as described herein the weight/weight ratio of longitudinal bands weight to transverse band/s weight is: 5:1-25:1. In one embodiment, in the net as described herein the weight/weight ratio of longitudinal bands weight to transverse band/s weight is: 8:1-12:1.

In one embodiment, a net as described herein or a net segment of 1 meter length and full width is characterized by a length/length ratio of total longitudinal bands length to total transverse band/s length of 6:1 to 1:6. In one embodiment, a net as described herein or a net segment of 1 meter length and full width is characterized by a length/length ratio of total longitudinal bands length to total transverse band/s length of 5:1 to 1:5. In one embodiment, a net as described herein or a net segment of 1 meter length and full width is characterized by a length/length ratio of total longitudinal bands length to total transverse band/s length of 4:1 to 1:4. In one embodiment, a net as described herein or a net segment of 1 meter length and full width is characterized by a length/length ratio of total longitudinal bands length to total transverse band/s length of 3:1 to 1:1. In one embodiment, a net as described herein or a net segment of 1 meter length and full width is characterized by a length/length ratio of total longitudinal bands length to total transverse band/s length of 1:1 to 1:3. In one embodiment, a net as described herein or a net segment of 1 meter length and full width is characterized by a length/length ratio of total longitudinal bands length to total transverse band/s length of 2:1 to 1:1. In one embodiment, a net as described herein or a net segment of 1 meter length and full width is characterized by a length/length ratio of total longitudinal bands length to total transverse band/s length of 1:1 to 1:2. In one embodiment, a net as described herein or a net segment of 1 meter length and full width is characterized by a length/length ratio of total longitudinal bands length to total transverse band/s length of 2.5:1 to 1:1. In one embodiment, a net as described herein or a net segment of 1 meter length and full width is characterized by a length/length ratio of total longitudinal bands length to total transverse band/s length of 1:1 to 1:2.5. In one embodiment, a net as described herein or a net segment of 1 meter length and full width is characterized by a length/length ratio of total longitudinal bands length to total transverse band/s length of 1:1 to 1:5. In one embodiment, a net as described herein or a net segment of 1 meter length and full width is characterized by a length/length ratio of total longitudinal bands length to total transverse band/s length of 1.5:1 to 1:1. In one embodiment, a net as described herein or a net segment of 1 meter length and full width is characterized by a length/length ratio of total longitudinal bands length to total transverse band/s length of 1.2 to 1:1. In one embodiment, a net as described herein or a net segment of 1 meter length and full width is characterized by a length/length ratio of total longitudinal bands length to total transverse band/s length of 1:1 to 1:1.2.

In one embodiment, a net as described herein or a net segment of 1 meter length and full width is characterized by a length/length ratio of total longitudinal bands length to total transverse band/s length of 1:2 to 1:15. In one embodiment, a net as described herein or a net segment of 1 meter length and full width is characterized by a length/length ratio of total longitudinal bands length to total transverse band/s length of 1:4 to 1:12. In one embodiment, a net as described herein or a net segment of 1 meter length and full width is characterized by a length/length ratio of total longitudinal bands length to total transverse band/s length of 1:6 to 1:10. In one embodiment, a net as described herein or a net segment of 1 meter length and full width is characterized by a length/length ratio of total longitudinal bands length to total transverse band/s length of 1:7 to 1:9. In one embodiment, a net as described herein or a net segment of 1 meter length and full width is characterized by a length/length ratio of total longitudinal bands length to total transverse band/s length of 1:8 to 1:8.5.

In one embodiment, a net as described herein, or a net segment of 1 meter length and full width is characterized or comprises 4 to 80 longitudinal bands. In one embodiment, a net as described herein, or a net segment of 1 meter length and full width is characterized or comprises 4 to 50 longitudinal bands. In one embodiment, a net as described herein, or a net segment of 1 meter length and full width is characterized or comprises 4 to 30 longitudinal bands. In one embodiment, a net as described herein, or a net segment of 1 meter length and full width is characterized or comprises 2 to 20 longitudinal bands. In one embodiment, a net as described herein, or a net segment of 1 meter length and full width is characterized or comprises 6 to 18 longitudinal bands. In one embodiment, a net as described herein, or a net segment of 1 meter length and full width is characterized or comprises 10 to 20 longitudinal bands. In one embodiment, a net as described herein, or a net segment of 1 meter length and full width is characterized or comprises 8 to 16 longitudinal bands. In one embodiment, a net as described herein, or a net segment of 1 meter length and full width is characterized or comprises 10 to 14 longitudinal bands.

In one embodiment, a net as described herein comprises 6 to 60 longitudinal bands per 0.6 to 2.7 m width of net. In one embodiment, a net of 0.6 to 2.7 m width as described herein comprises 6 to 60 longitudinal bands. In one embodiment, a net of 0.6 to 1 m width as described herein comprises 3 to 20 longitudinal bands. In one embodiment, a net of 0.6 to 1 m width as described herein comprises 4 to 12 longitudinal bands. In one embodiment, a net of 1 to 1.2 m width as described herein comprises 10 to 18 longitudinal bands. In one embodiment, a net of 0.8 to 1.7 m width as described herein comprises 5 to 30 longitudinal bands. In one embodiment, a net of 0.8 to 1.7 m width as described herein comprises 6 to 20 longitudinal bands. In one embodiment, a net of 1.8 to 3 m width as described herein comprises 6 to 60 longitudinal bands.

In one embodiment, a net as described herein comprises 4 to 14 longitudinal bands per 1-1.4 m width of the net. In one embodiment, a net as described herein comprises 6 to 12 longitudinal bands per 1-1.4 m width of the net. In one embodiment, a net as described herein comprises 10 to 16 longitudinal bands per 1-1.4 m width of the net. In one embodiment, a net as described herein, comprises 6 to 10 longitudinal bands per 1-1.4 m width of the net. In one embodiment, a net as described herein comprises 4 to 8 longitudinal bands per 1-1.4 m width of the net. In one embodiment, a net as described herein comprises 10 to 14 longitudinal bands per 1-1.4 m width of the net.

In one embodiment, the total length of a longitudinal band is 10 to 80 m. In one embodiment, the total length of a longitudinal band is 20 to 60 m. In one embodiment, the total length of a longitudinal band is 20 to 50 m. In one embodiment, the total length of a longitudinal band is 30 to 40 m. In one embodiment, the total length of a longitudinal band is 32 to 38 m. In one embodiment, the total length of a longitudinal band is 35 to 37 m.

In one embodiment, the total length of the longitudinal bands in a net is 100 to 1200 m. In one embodiment, the total length of the longitudinal bands in a net is 800 to 1200 m. In one embodiment, the total length of the longitudinal bands in a net is 400 to 1000 m. In one embodiment, the total length of the longitudinal bands in a net is 300 to 800 m. In one embodiment, the total length of the longitudinal bands in a net is 360 to 480 m. In one embodiment, the total length of a longitudinal band is 420 to 480 m.

In one embodiment, the total length of the transverse band in a net is 5 to 400 m. In one embodiment, the total length of the transverse band/s in a net is 10 to 100 m. In one embodiment, the total length of the transverse band/s in a net is 10 to 60 m. In one embodiment, the total length of the transverse band/s in a net is 15 to 45 m. In one embodiment, the total length of the transverse band/s in a net is 20 to 34 m. In one embodiment, the total length of a transverse band is 26 to 30 m.

In one embodiment, a net as described herein comprises 4 to 14 longitudinal bands. In one embodiment, a net as described herein comprises 6 to 12 longitudinal bands. In one embodiment, a net as described herein comprises 10 to 16 longitudinal bands. In one embodiment, a net as described herein comprises 8 to 14 longitudinal bands. In one embodiment, a net as described herein comprises 4 to 8 longitudinal bands. In one embodiment, a net as described herein comprises 10 to 14 longitudinal bands.

In one embodiment, a net as described herein, comprises 4 to 14 longitudinal bands per 1 m width of the net. In one embodiment, a net as described herein comprises 6 to 12 longitudinal bands per 1 m width of the net. In one embodiment, a net as described herein comprises 10 to 16 longitudinal bands per 1 to 1.2 m width of the net. In one embodiment, a net as described herein comprises 8 to 14 longitudinal bands per 1 m width of the net. In one embodiment, a net as described herein comprises 4 to 8 longitudinal bands per 1 m width of the net. In one embodiment, a net as described herein, comprises 10 to 14 longitudinal bands per 1 m width of the net.

In one embodiment, a net as described herein, comprises 1 to 50 transverse band/s. In one embodiment, a net as described herein comprises 1 to 50 transverse band/s per 1 m width of the net. In one embodiment, a net as described herein, has 1 transverse band. In one embodiment, a net as described herein, has 1 transverse band per 1 m width of the net. In one embodiment, a net as described herein, has 1 transverse band crossing a plurality of longitudinal bands. In one embodiment, a net as described herein, has 1 transverse band crossing a plurality of longitudinal bands in a zig zag manner or structure. In one embodiment, a net as described herein, has 1 transverse band having the form of a zigzag and crossing at least one or a plurality of longitudinal bands.

In one embodiment, per 1 m long net the 1 transverse band has 1-10 zig zag turns. In one embodiment, per 1 m long net the 1 transverse band has 2-8 zig zag turns. In one embodiment, per 1 m long net the 1 transverse band has 1-6 zig zag turns. In one embodiment, per 1 m long net the 1 transverse band has 2-5 zig zag turns. In one embodiment, per 1 m long net the 1 transverse band has 3-4 zig zag turns.

In one embodiment, per 1 m long net the 1 transverse band crosses an edge longitudinal band 1-10 times. In one embodiment, per 1 m long net the 1 transverse band crosses an edge longitudinal band 2-8 times. In one embodiment, per 1 m long net the 1 transverse band crosses an edge longitudinal band 1-6 times. In one embodiment, per 1 m long net the 1 transverse crosses an edge longitudinal band 2-5 times. In one embodiment, per 1 m long net the 1 transverse band crosses an edge longitudinal band 3-4 times.

In one embodiment, a net as described herein, or a net segment of 1 meter length and full width is characterized by a ratio of number of longitudinal bands to number of transverse band/s of 5:1 to 1.2:1. In one embodiment, a net as described herein, or a net segment of 1 meter length and full width is characterized by a ratio of number of longitudinal bands to number of transverse band/s of 4:1 to 1:1. In one embodiment, a net as described herein, or a net segment of 1 meter length and full width is characterized by a ratio of number of longitudinal bands to number of transverse band/s of 4:1 to 1.2:1. In one embodiment, a net as described herein, or a net segment of 1 meter length and full width is characterized by a ratio of number of longitudinal bands to number of transverse band/s of 3:1 to 1:1. In one embodiment, a net as described herein, or a net segment of 1 meter length and full width is characterized by a ratio of number of longitudinal bands to number of transverse band/s of 3:1 to 1.2:1. In one embodiment, a net as described herein, or a net segment of 1 meter length and full width is characterized by a ratio of number of longitudinal bands to number of transverse band/s of 2.5:1 to 1.5:1. In one embodiment, a net as described herein, or a net segment of 1 meter length and full width is characterized by a ratio of number of longitudinal bands to number of transverse band/s of 2:1 to 1.5:1. In one embodiment, a net as described herein, or a net segment of 1 meter length and full width is characterized by a ratio of number of longitudinal bands to number of transverse band/s of 2.2:1 to 1.6:1. In one embodiment, a net as described herein, or a net segment of 1 meter length and full width is characterized by a ratio of number of longitudinal bands to number of transverse band/s of 12:6 to 12:7. In one embodiment, a net as described herein, or a net segment of 1 meter length and full width is characterized by a ratio of number of longitudinal bands to number of transverse band/s of 12:6.5.

According to an aspect of some embodiments of the present invention there is provided a net comprising transverse and longitudinal bands wherein the adjustability of the net is independent of the elasticity of the transverse and longitudinal bands. In some embodiments, the net comprises adjustable shape of two-dimensional and three-dimensional geometries. In some embodiments, the transverse band is threaded through the channel of the longitudinal band to form a reticulate structure. In some embodiments, the adjustability of the longitudinal band and the transverse band in relation to each other at the intersections 114 comprises shiftable locations of the intersection along the length of the transverse band, angles between the transverse band and the longitudinal band at the intersection, and lengths of the transverse band between intersections 114.

In one embodiment, a longitudinal band comprises an edge. In one embodiment, an edge is positioned at a longitudinal edge or end of the net. In one embodiment, a longitudinal edge or end of the net comprises at least one longitudinal band or at least one edge of a longitudinal band. In one embodiment, each of the net's longitudinal edge or end comprises 1 to 10 longitudinal bands/edge longitudinal bands. In one embodiment, each of the net's longitudinal edge comprises 1 to 6 longitudinal bands/edge longitudinal bands. In one embodiment, each of the net's longitudinal edge consists of 1 longitudinal band/edge longitudinal band. In one embodiment, each of the net's longitudinal edge comprises 2 to 4 longitudinal bands/edge longitudinal bands.

In one embodiment, a transverse band further crosses an edge longitudinal band in a serpentine or zigzag manner. In one embodiment, a transverse band crosses an edge longitudinal band of the net and forms a semi-loop at one longitudinal edge of the net, another edge longitudinal of the net, or both. In one embodiment, the semi-loop extends beyond one edge of the net, another edge of the net, or both.

In one embodiment, a length (L) of the semi-loop corresponds to a predetermined distance (D) between an intersection of the semi-loop and at least one longitudinal band or an edge longitudinal band at one edge of the net, another edge of the net, or both.

In one embodiment, at least two adjacent segments of a transverse band threaded through at least one edge longitudinal band define between them a semi-loop locking portion of a longitudinal band or an edge longitudinal band (at the net's longitudinal edge). In one embodiment, the ratio between an area (a) of the locking portion exclusive of the channels and an area (b) inclusive of channels is expressed by (0.1b≥a).

In one embodiment, provided herein is a net, comprising: a plurality of transverse band/s; and a plurality of longitudinal bands; wherein each longitudinal band of longitudinal bands comprises two films, each longitudinal band comprises at least two adhered portions and a non-adhered portion therebetween forming a channel. In some embodiments, the channel is an opening formed between the films and/or at least partial discontinuity in the adhesion of the films between two adhered portions.

In some embodiments, each adhered portion of adhered portions ends with a channel; wherein the channel (and/or non-adhered portion) comprises a semi-adhered zone, a non-adhered zone or both wherein each transverse band of at least 50% of the transverse band/s is threaded through the channel forming an intersection between the longitudinal band and the transverse band. In one embodiment, one transverse band is threaded in at least two channels, wherein each channel of at least two channels is on a different longitudinal band. In one embodiment, at least one transverse band is threaded in at least two channels, wherein each channel of at least two channels is on a different longitudinal band.

In one embodiment, a semi-adhered zone, a non-adhered zone or both, is present only in a channel. In one embodiment, a semi-adhered zone, a non-adhered zone or both, is present only in a longitudinal band. In one embodiment, a semi-adhered zone is a zone wherein the films are loosely adhered to one another. In one embodiment, a semi-adhered zone is a zone wherein each one of the films is loosely adhered to a transverse band. In one embodiment, a non-adhered zone is a zone wherein the films are not adhered to one another. In one embodiment, a non-adhered zone is a zone wherein each one of the films is not adhered to a transverse band.

In one embodiment, the two films are glued to each other. In one embodiment, each film of the two films comprises two sides, wherein one side is sticky or comprises a glue and the other side is non-sticky or devoid of a glue. In one embodiment, the sticky side or the glue comprising side of each film of the two films are in contact within an adhered portion of the adhered portions. In one embodiment, the sticky side or the glue comprising side of each film of the two films are in contact the transverse band within the channel. In one embodiment, the transverse band is devoid of glue or a sticky side. In one embodiment, the transverse band comprises a single film devoid of a glue or a sticky side. In one embodiment, the longitudinal band comprises two film wherein each film has two sides (or surfaces) wherein one side or surface is devoid of a glue or a sticky side and the second side or surface comprises a glue or a sticky side.

In one embodiment, the thickness of the film making a transverse band is 5-250 μm. In one embodiment, the thickness of the film making a transverse band is 5-150 μm. In one embodiment, the thickness of the film making a transverse band is 5-50 μm. In one embodiment, the thickness of the film making a transverse band is 10-40 μm. In one embodiment, the thickness of the film making a transverse band is 20-50 μm.

In one embodiment, a tape comprises a pressure-sensitive adhesive. In one embodiment, a tape comprises fiberglass filaments. In one embodiment, a tape is a filament tape. In one embodiment, a tape comprises a pressure-sensitive adhesive coated onto a polypropylene or polyester film and fiberglass filaments embedded within. In one embodiment, a tape is comprised of liquid rubber. In one embodiment, a tape comprises ethylene propylene rubber (EPR). In one embodiment, a tape comprises polyisobutylene.

In one embodiment, a tape is a friction tape. In one embodiment, a tape comprises an adhesive impregnated onto it. In one embodiment, the adhesive is a rubber-based adhesive. In one embodiment, a tape is a self-amalgamating tape. In one embodiment, a tape is a non-tacky tape.

In one embodiment, a tape comprises a pressure-sensitive adhesive coated onto one side of the tape. In one embodiment, a pressure-sensitive adhesive is coated onto the tape wherein the tape is composed of a polypropylene or a polyester film. In one embodiment, a tape has strength in both the long (machine) direction and the cross direction. In one embodiment, a tape comprises an adhesive. In one embodiment, a tape comprises an acrylic adhesive. In one embodiment, the term “adhesive” and “glue” are used interchangeably.

In one embodiment, a tape comprises strip of thin plastic material. In one embodiment, a tape comprises latex. In one embodiment, a tape adheres only to itself or to another identical tape. In one embodiment, a tape is a cloth-or scrim-backed pressure-sensitive tape. In one embodiment, a tape is coated with polyethylene.

In one embodiment, “loosely adhered” is an adherence between two films having a strength, a bonding strength, adhesive power, cohesive power or any combination thereof which is at least 20%, 30%, 40%, 50%, 60%, 70%, 80%, or 90% less than the adherence the strength, the bonding strength, the adhesive power, the cohesive power or any combination thereof between two films within the adhered portion of a longitudinal band.

In one embodiment, provided herein is a net, comprising: a plurality of transverse band/s; and a plurality of longitudinal bands. In one embodiment, each longitudinal band of the longitudinal bands comprises two films. In one embodiment, each longitudinal band comprises at least two adhered portions. In one embodiment, an adhered portion is a portion, or an area characterized by adhesion between the two films. In one embodiment, each adhered portion borders one channel or two of channels.

In one embodiment, each channel of the channels comprises at least partial adhesion between the two films or between each film and the transverse band. In one embodiment, each channel of the channels comprises no adhesion between the two films or between each film and the transverse band. In one embodiment, each channel is configured to accommodate at least a portion of a transverse band between the films.

In one embodiment, each transverse band of at least 40%, 50%, 60%, 70%, 80%, 90% or all of the transverse band/s is threaded through each channel of the channels. In one embodiment, a transverse band threaded through a channel forms an intersection between the longitudinal band and transverse band. In one embodiment, the strength of the adherence, the bonding strength, the adhesive power, the cohesive power or any combination thereof between the transverse band and the channel at the intersection is at least 30% weaker than the strength of the adherence, the bonding strength, the adhesive power, the cohesive power or any combination thereof between the two films at the adhered portion/s.

In one embodiment, the transverse band occupies 90%, 80%, 75%, 70%, 60%, 50%, 40%, 30%, 20%, 10%, 5% or less of the channel area. In one embodiment, “the transverse band occupies” is synonymous with a transverse section of the transverse band.

In one embodiment, the ratio between the surface area of the adhered portions to the surface area of the channel is at least 2:1. In one embodiment, the ratio between the surface area of the adhered portions to the surface are of the channel is at least 2.5:1. In one embodiment, the ratio between the surface area of the adhered portions to the surface area of the channel is at least 3:1. In one embodiment, the ratio between the surface area of the adhered portions to the surface area of the channel is at least 4:1. In one embodiment, the ratio between the surface area of the adhered portions to the surface area of the channel is at least 5:1.

In one embodiment, the ratio between the surface area of the adhered portions to the surface area of the channel is between 1.5:1 to 100:1. In one embodiment, the ratio between the surface area of the adhered portions to the surface area of the channel is between 1.5:1 to 75:1. In one embodiment, the ratio between the surface area of the adhered portions to the surface area of the channel is between 2:1 to 50:1. In one embodiment, the ratio between the surface area of the adhered portions to the surface area of the channel is between 4:1 to 50:1.

In one embodiment, the transverse band is moveable within the channel. In one embodiment, the transverse band is translocatable within the channel. In one embodiment, the transverse band is moveable along the length of the channel, along the width of the channel or both. In one embodiment, the transverse band is translocatable within the length of the channel, the width of the channel or both.

In one embodiment, the orientation of the transverse band in relation to the longitudinal is adjustable. In one embodiment, the orientation of the transverse band in relation to the longitudinal within a channel is adjustable. In one embodiment, the angle between a transverse band and a longitudinal band with a channel is adjustable. In one embodiment, the intersection and or the channel is/are moveable and/or relocatable.

In one embodiment, the net is an adjustable net, which is a deformable structure composed of elements which can be non-deformable, rigid, semi-rigid, and/or elastic, and the like, such that the adjustability of the structure of the net 100 is formed at least partially by the adjustable orientation and/or position of the elements in relation to one another. In one embodiment, a net as described herein is stretchable.

In one embodiment, a net as described herein is stretchable by at least 1.5 of its initial length and/or width. In some embodiments, the net is stretchable by at least 1.2 of its initial length. In some embodiments, the net is stretchable by at least 1.7 of its initial length. In some embodiments, the net is stretchable by at least 1.2 of its initial width. In some embodiments, the net is stretchable by at least 1.5 of its initial width. In some embodiments, the net is stretchable by at least 1.7 of its initial width.

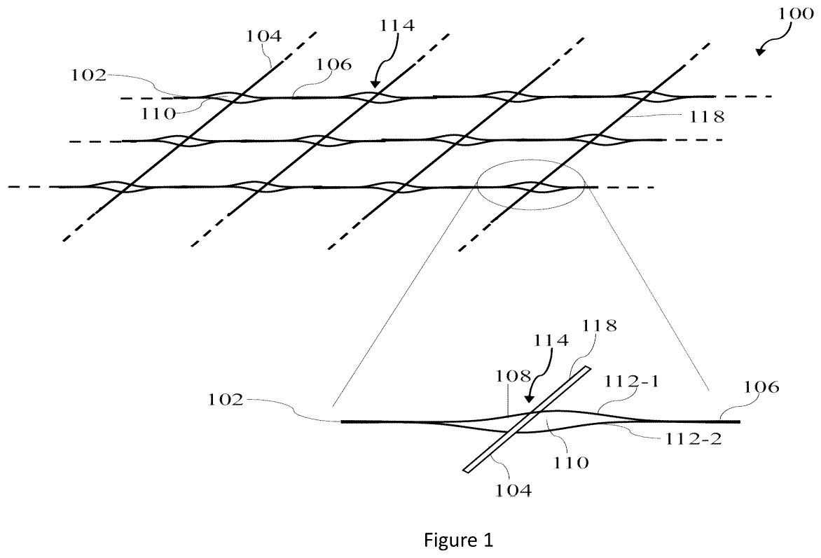

Reference is made to FIG. 1, which is a perspective view of an exemplary embodiment of a net in accordance with some embodiments of the present invention. In some embodiments, the net 100 comprises a plurality of longitudinal bands 102. In some embodiments, the net 100 comprises a plurality of transverse band/s 104. In some embodiments, the longitudinal band 102 comprises at least one channel 110 formed between two or more films 112. In some embodiments, the transverse band 104 is threaded between the films 112 and/or through the channel 110.

In some embodiments, a longitudinal band 102 comprises at least one channel 110. In some embodiments, each longitudinal band 102 comprises at least two channels 110. In some embodiments, at least one transverse band 104 is threaded through each channel 110. In some embodiments, one transverse band 104 is threaded through each channel 110. In some embodiments, a plurality of transverse band/s 104 are threaded through each channel 110.

In some embodiments, channel 110 is 0.5-30 mm wide. In some embodiments, channel 110 is 0.5-20 mm wide. In some embodiments, channel 110 is 1-10 mm wide. In some embodiments, channel 110 is 1.5-6 mm wide. In some embodiments, channel 110 is 2-8 mm wide. In some embodiments, channel 110 is 3-10 mm wide.

In some embodiments, the elements of the net 100, as described in greater detail elsewhere herein, are the longitudinal band 102 and/or the transverse band 104. In some embodiments, the intersection 114 of the transverse band 104 and the longitudinal band 102 is shiftable along the length of at least one of the transverse band/s 104 and the longitudinal band 102. In some embodiments, the net 100 is deformable, for example, by adjusting the position and/or orientation of the transverse band 104 within the channels 110.

A potential advantage in adjustable intersections 114 is in that a geometry of the net 100 is adjustable independently of the elasticity of the transverse and longitudinal bands 104/102.

A potential advantage of the adjustability of the longitudinal band 102 and the transverse band 104 in relation to each other at the intersections 114 is in that the adjustability of the structure of the net 100 is increased by establishing a range of positions and/or orientations of the transverse band 104 in relation to the longitudinal band 102. In some embodiments, the adjustability of the net 100 is independent of the elasticity of the transverse band/s 104 and longitudinal bands 102.

### Longitudinal Band

In some embodiments, the longitudinal band 102 is composed of two films 112-1 and 112-2, collectively referred to as films 112. In some embodiments, the films 112 comprise a cord, a wire, a belt, film, a thread, and the like. In some embodiments, the films 112 comprise tapes. In some embodiments, the longitudinal band 102 comprises two layered films 112. In some embodiments, the films 112 are similar in shape and size. In some embodiments, and as described in greater detail elsewhere herein, the films 112 are at least partially adhered to each other.

In some embodiments, the films 112 comprise inner surfaces (e.g., inner surfaces 122-1 and 122-2, collectively referred to as inner surfaces 122) which are facing each other. In some embodiments, the inner surfaces 122 of the films 112 are adhered at least two adhered portions 106 along the longitudinal band 102. In some embodiments, a portion of the inner surfaces 122 are sticky at least at the adhered portions 106 of the longitudinal band 102. In some embodiments, the inner surfaces of the films 112 comprise an adhesive. For example, in some embodiments, such as the exemplary embodiment depicted by FIG. 1, the longitudinal band 102 comprises two films 112 stuck to each other.

In some embodiments, the films 112 are touching, adhered, coupled, bound, glued, connected, joining, bordering, attached, bonded, or any combination thereof.

In some embodiments, the longitudinal band 102 is flexible, semi-rigid, rigid, elastic, deformable, ductile, stretchable, and the like. In some embodiments, the longitudinal band 102 is composed of materials such as steels, polymers, alloys, polyethylene, plastics, elastic polymers, metals, or any combination thereof.

In some embodiments, the width of the longitudinal band 102 is 1-650 mm. In some embodiments, the width of the longitudinal band 102 is 1-150 mm. In some embodiments, the width of the longitudinal band 102 is 4-500 mm. In some embodiments, the width of the longitudinal band 102 is 4-500 mm. In some embodiments, the width of the longitudinal band is 10-400 mm. In some embodiments, the width of the longitudinal band is 10-100 mm. In some embodiments, the width of the longitudinal band is 150-300 mm. In some embodiments, the width of the longitudinal band is 250-400 mm. In some embodiments, the width of the longitudinal band is 50-200 mm. In some embodiments the width of the longitudinal band 102 constant. In some embodiments, the width of the longitudinal band 102 varies. In some embodiments, the width of the longitudinal band 102 is 2-20 mm. In some embodiments, the width of the longitudinal band 102 is 4-15 mm. In some embodiments, the width of the longitudinal band 102 is 4-10 mm. In some embodiments, the width of the longitudinal band 102 is 5-9 mm. In some embodiments, the width of the longitudinal band 102 is 6-8 mm. In some embodiments, the width of the longitudinal band 102 is 5-8 mm.

In one embodiment, a tape's width is from 2 mm to 650 mm. In one embodiment, a tape's width is from 5 mm to 75 mm. In one embodiment, a tape's width is from 5 mm to 10 mm. In one embodiment, a tape's width is from 6 mm to 8 mm. In one embodiment, a tape's width is from 10 mm to 75 mm. In one embodiment, a tape's width is from 10 mm to 50 mm. In one embodiment, a tape's width is from 50 mm to 200 mm. In one embodiment, both tapes of the two tapes have the same width. In one embodiment, both tapes of the two tapes have the same length. In one embodiment, both tapes of the two tapes have the same thickness. In one embodiment, both tapes of the two tapes and the longitudinal band have the same width. In one embodiment, both tapes of the two tapes and the longitudinal band 102 have the same length.

In one embodiment, the tape's thickness is 5 to 100 μm. In one embodiment, the tape's thickness is 5 to 80 μm. In one embodiment, the tape's thickness is 10 to 50 μm. In one embodiment, the tape's thickness is 0.02 to 1 mm. In one embodiment, the tape's thickness is 0.05 to 1 mm. In one embodiment, the tape's thickness is 0.05 to 0.5 mm. In one embodiment, the tape's thickness is 0.06 to 0.8 mm. In one embodiment, the tape's thickness is 0.08 to 0.5 mm. In one embodiment, the tape's thickness is 10 to 200 microns. In one embodiment, the tape's thickness is 40 to 140 microns. In one embodiment, the tape's thickness is 60 to 80 microns.

In one embodiment, the longitudinal band 102 comprises two intermittently adhered films. In one embodiment, the transverse band comprises two intermittently adhered films. In one embodiment, the transverse band comprises a single film or a single layer.

In one embodiment, the longitudinal band's 102 thickness is 0.03 to 2 mm. In one embodiment, the longitudinal band's thickness is 0.05 to 1.8 mm. In one embodiment, the longitudinal band's thickness is 0.1 to 1 mm. In one embodiment, the longitudinal band's 102 thickness is 0.12 to 1.8 mm. In one embodiment, the longitudinal band's 102 thickness is 0.16 to 1.2 mm. In some embodiments, the longitudinal band 102 comprises at least two adhered portions 106 in which the films 112 are adhered. In some embodiments, the adhered portions 106 confine a channel 110 between thereof. In one embodiment, the longitudinal band's 102 thickness is 10 to 500 μm. In one embodiment, the longitudinal band's 102 thickness is 20 to 350 μm. In one embodiment, the longitudinal band's 102 thickness is 50 to 350 μm. In one embodiment, the longitudinal band's 102 thickness is 20 to 150 μm. In one embodiment, the longitudinal band's 102 thickness is 50 to 200 μm. In one embodiment, the longitudinal band's 102 thickness is 200 to 350 μm. In one embodiment, the longitudinal band's 102 thickness is 80 to 250 μm. In one embodiment, the longitudinal band's 102 thickness is 20 to 150 μm. In one embodiment, the longitudinal band's 102 thickness is 40 to 100 μm. In one embodiment, the longitudinal band's 102 thickness is 60 to 80 μm. In one embodiment, the longitudinal band's 102 thickness is 100 to 300 μm. In one embodiment, the longitudinal band's 102 thickness is 100 to 200 μm. In one embodiment, the longitudinal band's 102 thickness is 140 to 170 μm. In one embodiment, the longitudinal band's 102 thickness is 200 to 600 μm. In one embodiment, the longitudinal band's 102 thickness is 200 to 400 μm. In one embodiment, the longitudinal band's 102 thickness is 2800 to 340 μm.

### Adhered Portion

In some embodiments, the total surface area of the adhered portions 106 is at least 50%, 60%, 70%, 80%, or 90% of the total surface area of the longitudinal band 102, or any value and range therebetween.

In some embodiments, the length of the adhered portion 106 along the length of the longitudinal band 102 is 0.5-150 mm. In some embodiments, the length of the adhered portion 106 is 0.5-75 mm. In some embodiments, the length of the adhered portion 106 is 1-25 mm. In some embodiments, the length of the adhered portion 106 is 1-13 mm. In some embodiments, the length of the adhered portion 106 is 1-7 mm.

In some embodiments, each longitudinal band 102 comprises adhered portions 106 of equal lengths. In some embodiments, the length of the adhered portions 106 vary along each individual longitudinal band 102.

In some embodiments, and as described in greater detail elsewhere herein, the film 112 comprises a tape. In some embodiments, and as described in greater detail elsewhere herein, the tape comprises one or more of a filament tape, a friction tape, a self-amalgamating tape, which comprise adhesion properties such as bonding strength and/or friction.

### Channel

In some embodiments, the longitudinal band 102 comprises a plurality of channels 110. In some embodiments, channel 110 is shaped to accommodate the transverse band 104 through channel 110. In some embodiments, the channels 110 are formed by discontinuities in the intermittent adhesion of the longitudinal band 102. In some embodiments, at least 50% of the adhered portions 106 within a net 100 as described herein each confine at least two channels 110. In some embodiments, at least 60% to 80% of the adhered portions 106 within a net 100 each confine at least two channels 110.

In some embodiments, channel 110 between two films 112 of the longitudinal band 102 comprises an opening, a partial opening, a partial adhesion, and/or no adhesion between the films 112. In some embodiments, opening comprises a gap, slot, and/or discontinuity of the adhesion between two films 112. In some embodiments, and as described in greater detail elsewhere herein, channel 110 comprises a semi-adhered zone, a non-adhered zone or both. In some embodiments, channel 110 houses the transverse band 104.

In one embodiment, a semi-adhered zone comprises one or more of a zone wherein the films 112 are loosely adhered to one another and a zone wherein at least one film 112 is loosely adhered to the transverse band 104. For example, in some embodiments, the loosely adhered films 112 comprise an adhesive wherein the strength of the adhesive is weaker than the strength of the adhesion between the films 112 at the adhered portions 106. For example, in some embodiments, the loosely adhered films 112 comprise surfaces which have frictional interaction with each other and/or with the transverse band 104.

For example, in some embodiments, the loosely adhered film 112 and transverse band 104 comprise an adhesive wherein the strength of the adhesive is weaker than the strength of the adhesion between the films 112 at the adhered portions 106.

In some embodiments, the semi-adhered zone comprises adhesion which is at least 30%, 40%, 50%, 60%, 70%, 80%, or 99% weaker than the adhesion between the films 112 of the longitudinal band 102, or any value or range therebetween.

In some embodiments, the non-adhered zone comprises a zone wherein one or both films 112 are not adhered to the transverse band 104, and/or the films 112 are not adhered to one another.

In some embodiments, channel 110 houses the transverse band 104. In some embodiments, channel 110 houses the 1-3 transverse band/s 104. In some embodiments, channel 110 is adapted to provide an opening which houses the transverse band 104. In some embodiments, channel 110 is adapted to provide an opening which houses the transverse band 104 and an area of 20 to 200% of the width of the transverse band 104. In some embodiments, channel 110 is adapted to provide an opening which houses the transverse band 104 and an area of 30% to 150% of the width of the transverse band 104. In some embodiments, channel 110 is adapted to provide an opening which houses the transverse band 104 and an area of 40% to 100% of the width of the transverse band 104.

In some embodiments, the width of transverse band is 0.1 to 40 mm. In some embodiments, the width of transverse band is 0.5 to 40 mm. In some embodiments, the width of transverse band is 0.5 to 20 mm. In some embodiments, the width of transverse band is 0.5 to 10 mm. In some embodiments, the width of transverse band is 1 to 20 mm. In some embodiments, the width of transverse band is 1 to 10 mm. In some embodiments, the width of transverse band is 2 to 5 mm.

In some embodiments, the ratio between the surface area of the outer surface of the films 112 at the adhered portion 106 and the surface area of the outer surface of the films 112 at the channel 110 is 40:1, 30:1, 20:1, 15:1, 10:1, 9:1, 8:1, 6:1, 4:1, or 2:1, or any value and/or range therebetween. For example, in the exemplary embodiment depicted by FIG. 1, the ratio between the surface area of the outer surface of the films 112 at the adhered portion 106 and the surface area of the outer surface of the films 112 at the channel 110 is 3:1. In some embodiments, the width of the films 112 at the adhered portion 106 is equal to the width of the films 112 at the channel 110.

In some embodiments, the width of channel 110 is defined as a distance across the channel 110which is parallel to the length of the longitudinal band 102. In some embodiments, channel 110 is at least 2 mm wider than the transverse band 104. In some embodiments, channel 110 is at least 5 mm wider than the transverse band 104. In some embodiments, the width of channel 110 is 1-20 mm larger than the width of the transverse band 104.

In some embodiments, the width of channel 110 is 5-40 mm larger than the width of the transverse band 104. In some embodiments, the width of channel 110 is 5-20 mm larger than the width of the transverse band 104. In some embodiments, the width of channel 110 is 5-10 mm larger than the width of the transverse band 104. In some embodiments, the width of channel 110 is 1-5 mm larger than the width of the transverse band 104. In some embodiments, the width of channel 110 is constant. In some embodiments, the width of the channel 110 varies. In some embodiments, the difference between the width of channel 110 and the width of the transverse band 104 defines the range of distance in which the transverse band 104 can adjust within channel 110.

A potential advantage of the width of the channel 110 being larger than the width of the transverse band 104 is in that the position and/or orientation of the transverse band 104 is adjustable within the channel 110, which increases the adjustability of the structure of the net 100 independently form the elasticity of the longitudinal band 102 and/or transverse band 104.

A potential advantage of the longitudinal band 102 comprising a channel 110 is in that the surfaces of the transverse band can remain parallel to the surfaces of the longitudinal band within the channel 110, which maintains the net 100 flat. A flat net 100 can be rolled onto a roller during unpacking and/or for efficient storage.

A potential advantage of the films 112 having a stronger adhesion than the adhesion within the channel 110 is in that the dimensions of the adhered portions 106 and/or channels 110 of the longitudinal band 102 are not altered by forces applied to the net 100. In some embodiments, the adherence of the films 112 prevents external forces applied onto the longitudinal band 102 from deforming the channel 110. In some embodiments, the adherence of the films 112 prevents external forces applied onto the transverse band 104 from deforming the channel 110.

### Transverse Band

In some embodiments, the transverse band 104 comprises a cord, a wire, a belt, a film, a thread, and the like. In some embodiments, the transverse band 104 comprises at least a portion having dimensions sufficient to fit within the channel 110 of the longitudinal band 102.

In some embodiments, the transverse band 104 is flexible, semi-rigid, rigid, elastic, deformable, stretchable, ductile, and the like. For example, in some embodiments, the transverse band 104 is composed of materials such as steels, polymers, alloys, metals, polyethylene, plastics, elastic polymers, or any combination thereof.

In some embodiments, the thickness of the transverse band 104 is 0.03 to 2 mm. In some embodiments, the thickness of the transverse band 104 is 0.05-1.8 mm. In some embodiments, the thickness of the transverse band 104 is 0.1-1 mm. In some embodiments, the thickness of the transverse band 104 is 0.12-1.8 mm. In some embodiments, the thickness of the transverse band 104 is 0.04-1.3 mm. In some embodiments, the thickness of the transverse band 104 is 5 to 200 μm thick. In some embodiments, the thickness of the transverse band 104 is 7 to 150 μm thick. In some embodiments, the thickness of the transverse band 104 is 10 to 100 μm thick. In some embodiments, the thickness of the transverse band 104 is 20 to 50 μm thick. In some embodiments, the thickness of the transverse band 104 is 30 to 50 μm thick. In some embodiments, the thickness of the transverse band 104 is 5 to 50 μm thick. In some embodiments, the thickness of the transverse band 104 is 20 to 80 μm thick. In some embodiments, the thickness of the transverse band 104 is 50 to 150 μm thick. In some embodiments, the thickness of the transverse band 104 is 20 to 60 μm thick. In some embodiments, the thickness of the transverse band 104 is constant. In some embodiments, the thickness of the transverse band 104 varies.

In some embodiments, the thickness of the transverse band 104 is smaller than or equal to the height of the opening of channel 110. In some embodiments, the thickness of the transverse band 104 is sufficient to fit within the opening of channel 110 such that the transverse band 104 abuts against both films 112 of the channel 110.

In some embodiments, the width of the transverse band 104 is shorter than the width of the channel 110. In some embodiments, the width of the transverse band 104 is 1-50 mm. In some embodiments, the width of the transverse band 104 is 0.2-30 mm. In some embodiments, the width of the transverse band 104 is 0.5-15 mm. In some embodiments, the width of the transverse band 104 is 3-17 mm. In some embodiments, the width of the transverse band 104 is 2 to 40 mm. In some embodiments, the width of the transverse band 104 is 2 to 10 mm. In some embodiments, the width of the transverse band 104 is 5 to 50 mm. In some embodiments, the width of the transverse band 104 is 15 to 35 mm. In some embodiments, the width of the transverse band 104 is 2 to 10 mm. In some embodiments, the width of the transverse band 104 is 2 to 5 mm.

In some embodiments the width of the transverse band 104 constant. In some embodiments, the width of the transverse band 104 varies.

In some embodiments, the transverse band 104 folds within the channel 110, such that the width of the transverse band 104 within the channel 110 is smaller than a flattened transverse band 104.

In some embodiments, the transverse band 104 occupies 90% or less of the channel 110 area. In some embodiments, the transverse band 104 occupies 70% or less of the channel 110 area. In some embodiments, the transverse band 104 occupies 60-99% of the channel 110 area. In some embodiments, the transverse band 104 occupies 10-65% of the channel 110 area.

In some embodiments, the transverse band occupies 2% to 50% of: (a) the surface area of the inner surfaces; or (b) the channel 110 area. In some embodiments, the transverse band occupies 3% to 30% of: (a) the surface area of the inner surfaces; or (b) the channel 110 area. In some embodiments, the transverse band occupies 5% to 20% of: (a) the surface area of the inner surfaces; or (b) the channel 110 area. In some embodiments, the transverse band occupies 2% to 15% of: (a) the surface area of the inner surfaces; or (b) the channel 110 area. In some embodiments, the transverse band occupies 10% to 40% of: (a) the surface area of the inner surfaces; or (b) the channel 110 area.

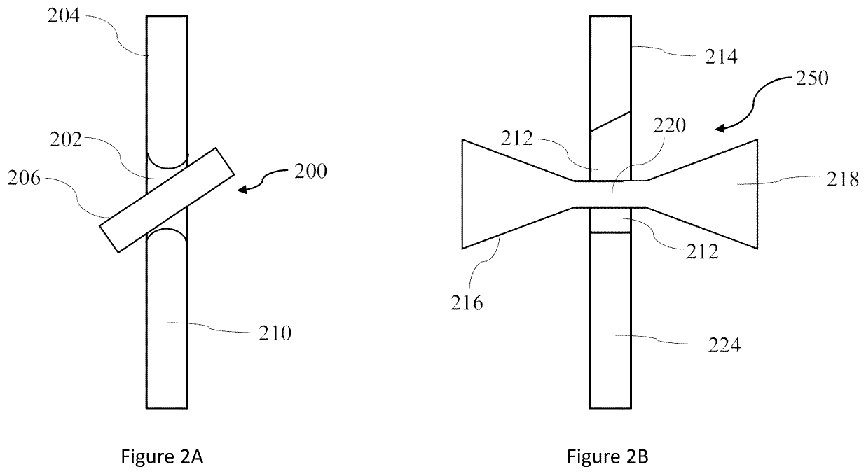

In some embodiments, the transverse band comprises a portion within the channel 110 and an outer portion 118 which remains outside of the channel 110. In some embodiments, the dimensions of the outer portion 118 are larger than the dimensions of the channel 110 (as described in greater detail elsewhere herein and depicted by FIG. 2B). For example, in some embodiments, the width of the outer portion 118 is larger than the width of the channel 110. In some embodiments, the outer portion 118 is sized and positioned such that the transverse band 104 has limited mobility along the longitudinal axis of the transverse band 104. In some embodiments, the motion of the transverse band 104 within the channel 110 is limited by the portion 118.

In some embodiments, the transverse band 104 comprises the outer portion 118 at one side or both sides of the channel 110, such that movement of the transverse band 104 is limited within the channel 110. In some embodiments, the transverse band 104 comprises at least one outer portion 118 at least one side of the channel 110, such that movement intersection 114 along the length of the transverse band 104 is limited in at least one direction.

In some embodiments, the distance between two consecutive outer portions 118 is 20-90 mm. In some embodiments, the distance between two consecutive outer portions 118 is 30-100 mm. In some embodiments, the distance between two consecutive outer portions 118 is 40-60 mm.

Reference is made to FIGS. 2A and 2B, which are cross section views of exemplary embodiments of intersections within a net in accordance with some embodiments of the present invention. In the exemplary embodiments depicted by FIGS. 2A and 2B, the longitudinal bands 204/214 comprise one film 210/224 on either side of the transverse band/s 206/216 at each intersection 200/250.

In some embodiments, such as depicted by FIG. 2A, channel 202 is shaped to accommodate the transverse band 206. In some embodiments, such as depicted by FIG. 2A, channel 202 is shaped to accommodate a single transverse band 206. In some embodiments, channel 202 is shaped to accommodate the transverse band 206 at a range of orientations in relation to the longitudinal band 204.

In some embodiments, such as depicted by FIG. 2B, the width of the transverse band 216 varies. In some embodiments, the width of portion 220 of the transverse band within channel 212 is smaller than the width of channel 212. In some embodiments, the width of portion 218 of the transverse band 216 outside of channel 212 is larger than the width of the channel 212. In some embodiments, the distance between the portions 218 of the transverse band 216 which are wider than the channel 212 determined the range of mobility of intersection 250 along the length of the transverse band 216.

In some embodiments, channel 212 is asymmetrical. In some embodiments, the asymmetrical channel 212 prevents the transverse band 216 from sliding through the channel in only one direction along the length of the transverse band 216.

In some embodiments, a net as described herein has a stretching capacity of 100%. In some embodiments, a net as described herein can stretch and double its length. In some embodiments, a net as described herein has a stretching capacity of 1.2, 1.4, 1.6, 1.8, 2, 2.2, 2.5, 2.8 or any value therebetween.

In some embodiments, a net as described herein has a stretching capacity before brake of 100%. In some embodiments, a net as described herein can stretch and double its length before braking. In some embodiments, a net as described herein has a stretching capacity before brake of 1.2, 1.4, 1.6, 1.8, 2.0, 2.2, 2.5, 2.8 or any value therebetween.

In some embodiments, a net as described herein can carry or lift (above ground surface) up to 400 kg, 300 kg, 250 kg, 230 kg, 200 kg, 180 kg, 170 kg, 160 kg, 140 kg, 130 kg , 120 kg, 100 kg, 80 kg, 70 kg, 60 kg, 50 kg, 40 kg, 30 kg or any value therebetween before braking.

### Intersection

In some embodiments, the net 100 comprises a plurality of intersections 114. In some embodiments, intersection 114 comprises a first film, e.g. film 112-1, a transverse band 104 and a second film, e.g., 112-2. In some embodiments, the first and second films 112-1 and 112-2 are components of the longitudinal band 102. In some embodiments, at least a portion of the surface of the first film 112 is adhered to at least a portion of the surface of the second film. In some embodiments, one or both films 112 comprise sticky sides. In one embodiment, an intersection 114 comprises a transverse band 104 sandwiched between two films 112.

In some embodiments, an intersection 114 comprises a first portion comprising a first film 112, a transverse band 104 and a second film and a second portion comprising a first film 112 and a second film 112 without a transverse band 104. In some embodiments, intersection 114 comprises 3 regions wherein the first and the third regions comprise the first portion and the second region comprises the second portion. In one embodiment, the second region is sandwiched between the first and third regions.

In some embodiments, the adhesion between the transverse band 104 and each of films 112 of the longitudinal band 102 is such that applying a force above a threshold value to the one of the bands of an intersection 114 changes the orientation of one band in relation to another.

In some embodiments, the adhesion between the transverse band 104 and the one or more of the films 112 of the longitudinal band 102 comprises lateral adhesion.

In some embodiments, the transverse band 104 is slidable within the channel 110. In some embodiments, the location of the intersection 114 along the length of the transverse band 104 is adjustable. In some embodiments, the orientation of the transverse band 104 is adjustable in relation to the channel 110 and/or the longitudinal band 102.

### Reticulate Structure

In some embodiments, the net 100 comprises a reticulate structure. In some embodiments, the reticulate structure is symmetrical. In some embodiments, the reticulate structure is a grid or grid-like.

In some embodiments, at least one transverse band 104 is positioned within the channels 110 of the longitudinal bands 102 such that applying a pulling force onto the transverse band 104 reduces one or more of the width, length, or thickness of at least a portion of the net 100. In some embodiments, and as explained in greater detail elsewhere herein, the structure of the net 100 is adjusted to form fittingly wrap a three-dimensional object.

In some embodiments, the length of a diagonal of the net 100 is elongated by changing the position of the point of intersection 114 along the length of one or more transverse band/s 104. In some embodiments, of the elongation ability of the net 100 is increased by removing a transverse band 104 from one or more channels 110.

### Net Tensioning Control System

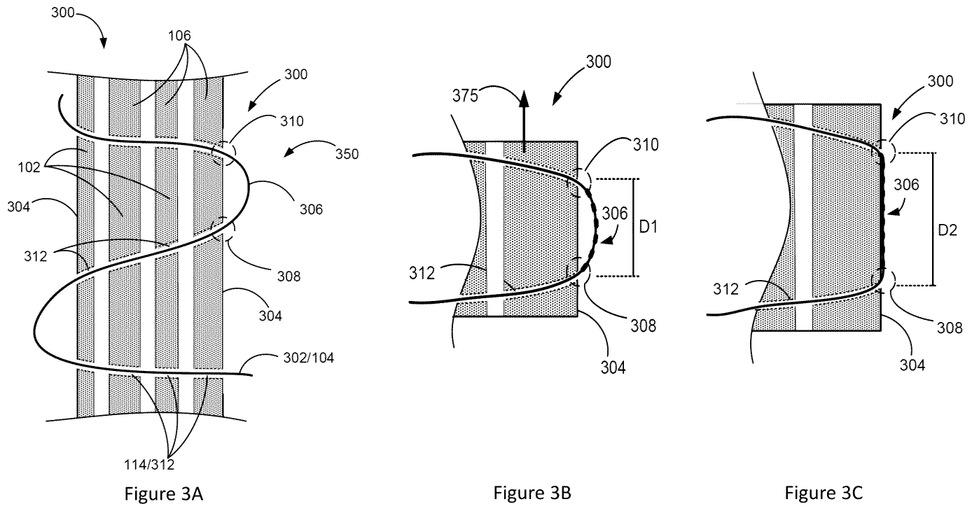

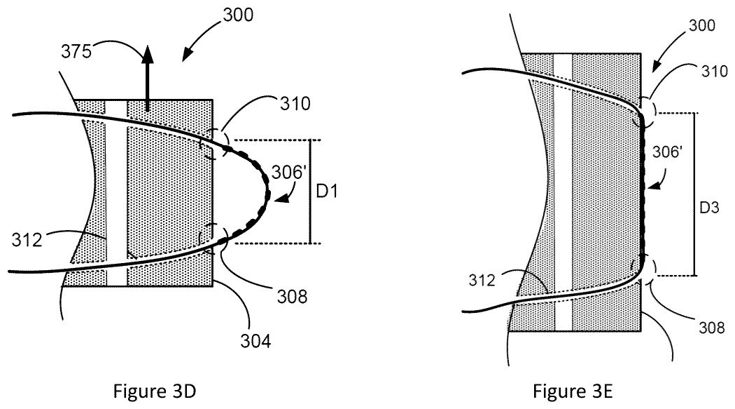

Referring now to FIGS. 3A, 3B, 3C and 3D, which are plan view simplified illustrations of a net tensioning control system in accordance with some embodiments of the current invention. In some embodiments and as explained elsewhere herein, a net 300 comprises adhered portions 106 along longitudinal bands 102 one or more transverse band/s 104 crossing one or more longitudinal bands 102 from one side of net 300 to another via one or more channels 312, similar to channels 110 described elsewhere herein, in a serpentine or zigzag manner. In some embodiments, net 300 comprises one or more transverse band/s 104 which cross an edge-longitudinal-band 304 of net 300 in a serpentine or zigzag manner.

In some cases, net 300 may enclose items having an asymmetrical geometry, bulging and/or protruding portions. Therefore, in some embodiments, net 300 is stretchable at least along a longitudinal axis thereof. However, overstretching may, in some cases, bring about loss of elasticity of the net 300 fibers/bands or even tearing of the net fibers/bands. Hence, in some embodiments, net 300 comprises a net tensioning control system 350 that limits the extent of stretching of net 300 and prevents overstretching and possibly tearing of the net.

In some embodiments, net tensioning control system 350 comprises one or more transverse band/s 302 that run through net 300 in a serpentine manner or zigzag manner. In some embodiments, net tensioning control system 350 comprises one or more transverse band/s 302 that cross, circle and or surround an edge-longitudinal-band 304 of net 300 in a serpentine or zigzag manner. In some embodiments, band 302 runs through net 300 or cross, circle and or surround an edge-longitudinal-band following other patterns e.g., parallel to the edge or edges of net 300, in a crisscross pattern, a zigzag pattern (Z-pattern or N-pattern) or any other pattern that is compliant with increasing tension on net 300 over a material being packed.

In some embodiments, and as shown in FIG. 3A, transverse band 302 extends beyond the edges 304 of net 300 or an edge-longitudinal-band 304 by exiting and reentering channels 312 at adjustable intersections 114 at one or more edges 304 of net 300 to form one or more semi-loops 306. For example, transverse band 302 may exit at an exit point 308 from a channel 312 and reenter the edge 304 of net 300 via entry point 310 at a second channel 312. In some embodiments, transverse band 302 forms one or more semi-loops 306 at predetermined locations, e.g., at locations disposed to tearing like at folds or bends of net 300. Alternatively, and optionally, transverse band 302 forms semi-loops 306 in a repetitive pattern throughout a dimension e.g., edge, of net 300. In one embodiment, edges 304 is or comprises an edge-longitudinal-band 304.

In some embodiments, transverse band 302 is threaded through net 300, for example, between the films 112 of a band and/or through channels 110 and/or a dedicated channel 312 shaped to have a geometry that corresponds to and supports accommodation of band 302. In some embodiments, transverse band 302 is at least partially adhered to net 300 at one or more locations in dedicated channel e.g., at a junction, an intersection or a crossing as explained in greater detail elsewhere herein. In some embodiments, adherence of transverse band 302 is the same at exit and entry points 308/310 as along adherence points in channels 110 and/or a dedicated channel 312. In some embodiments, adherence of transverse band 302 is greater at entry and exit points 308/310 than the adherence of transverse band 302 along adherence points in channels 110 and/or a dedicated channel 312.

The exemplary embodiments depicted in Figure pair numbers 3B/3C and 3D/3E, transverse band 302 forms a semi-loop 306 having a generally fixed length (L) and protrudes outside one or more edges 304 of net 300 between exit and entry points 308/310 located at a distance (D1) from each other. As illustrated in FIGS. 3B/3C, once net 300 is stretched, for example, in a direction indicated by an arrow designated reference number 375, the distance between exit and entry points 308/310 increases from a distance (D1) to a distance (D2) i.e., (D2)>(D1) as a result of which semi-loop 306, having a generally fixed length (L), is drawn axially and straightens, parallel to the direction indicated by arrow 350 to conform to and be urged along its length against edge 304 of net 300.

In some embodiments, semi-loop 306 serves as a visual indicator of the amount of stretching of net 300 in that the amount of stretching of net 300 corresponds to the level of flatness or proximity of the length dimension of semi-loop 306 to edge 304 of net 100. To that effect, the length (L1) of semi-loop 306 depicted in FIG. 3B is designed to be generally equal to the post-stretching distance (D2) of net 300 between exit and entry points 308/310 (L1=D2). Hence, the length (L) of semi-loop 306 is equal to a maximal allowable distance (D2).

In some embodiments, the length (L) of semi-loop 306 is predetermined in accordance with a desired limit of stretchability of net 300. For example, and as shown in FIGS. 3D and 3E, loop 306′ has a length (L2) that allows net 300 to stretch to a limited distance (D3), i.e., (L2=D3) wherein distance (D3) is greater than distance (D2) of FIG. 3C (D3>D2). In this example, (L2/L1) is proportional to (D3/D2).

In some embodiments, during stretching of net 300 there is at least some movement/sliding of transverse band 302 within channels 110 of adjustable intersections 114 bringing about some distribution of transverse band 302 throughout net 300. This minor distribution of transverse band 302 has negligible if any effect on lengthening of semi-loop 306 along edge 304 of net 300 during stretching.

In some embodiments, the maximal allowable stretchability of net 300 depends on, for example, the material of which longitudinal bands 102 are made, the degree of adhesion of transverse band 104/302 within channels 312 and the density of transverse band 302 crossings. In some embodiments, transverse band 302 is made of a non-compliant material. In some embodiments, transverse band 302 is made of a material less compliant than the material of which net 300 is made e.g., having a Young modulus (E_{band}) equal to or smaller than a Young modulus of the net (Eₙₑₜ) . In some embodiments, transverse band 302 is made of an elastic material the elastic limit of which is reached under tensile forces smaller than those required for tearing of the fibers of net 300. In some embodiments, the type of material of transverse band 302 depends on the degree of elasticity of net 300 or the desired degree of stretchability of net 300 regardless of the level of elasticity of transverse and longitudinal bands 104/102 themselves.

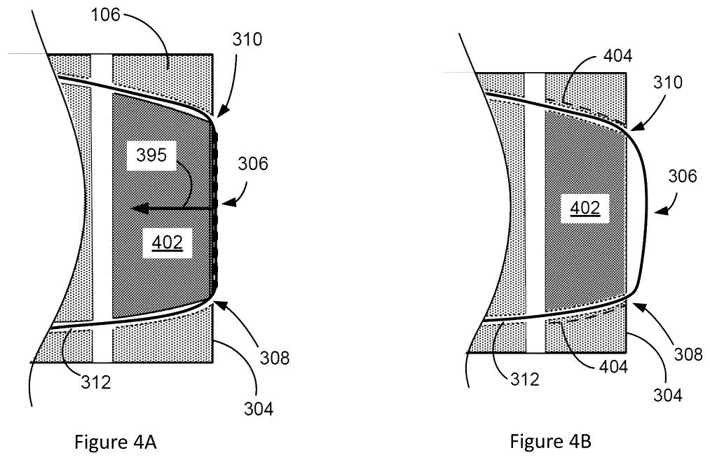

Reference is now made to FIGS. 4A and 4B, which are plan view simplified illustrations of net 300 tensioning system in accordance with some embodiments of the current invention. In some embodiments, semi-loop 306 serves as a physical limiter of overstretching of net 300. As shown in FIG. 4A, net tensioning control system 300 comprises a transverse band 302 semi-loop 306 locking portion 402 along one or more edge longitudinal bands (at the net's longitudinal edge) 106 at one or more edges 304 of net 300 that stops the stretching of transverse band 302 from tearing net 300.

In one embodiment, edges or edge is a longitudinal edge. In one embodiment, an edge or edges comprise a portion of longitudinal bands positioned at the edges or the longitudinal edges of the net. In one embodiment, a net comprises 2 longitudinal edges. In one embodiment, each longitudinal edge comprises at least one longitudinal band. In one embodiment, each longitudinal edge comprises 1 to 10 longitudinal bands. In one embodiment, each longitudinal edge comprises 1 to 6 longitudinal bands. In one embodiment, each longitudinal edge comprises 2 to 4 longitudinal bands. In some embodiments and as explained elsewhere herein, net 300 transverse band 302 is disposed along adherence points in channels 110 and/or dedicated channels 312. In some embodiments, adherence of transverse band 302 within one or more channels 110 and/or a dedicated channel 312 at edge portions of net 300, e.g., along an edge 304 band 106, is stronger than the adherence of transverse and longitudinal bands 104/102 of net 300 at non-edge 304 portions of net 300. This configuration forms a locking portion 402 along one or more edge portions of net 300, disposed between one or more channels 110 and/or a dedicated channel 312. In some embodiments, one or more portions of transverse band 104/302 are coated with an adhesive. In some embodiments, transverse band 104/302 is coated in its entirety with an adhesive. In some embodiments, one or more portions of transverse band 104/302 are welded and/or adhered to one or more longitudinal bands 106.

A potential advantage of this configuration is in that local variation in stretching of net 300 does not affect edges 304 of net 300 e.g., do not bring about tearing of edges 304. A potential advantage of a locking portion 402 is in that when net 300 is tensioned, locking portion 402 stops semi-loop 306 from moving from edges 304 inwards towards the center of net 300 in a direction indicated by arrow 395.

In some embodiments, the ratio between the area (a) of locking portion 402 and the area (b), marked by broken lines 404, which comprises area (a) and includes channels 110 and/or a dedicated channel 312 is (0.1b>a). The area (b) of net 300 is determined by the density of net 300 longitudinal and transverse band/s and not necessarily by the stretchability of net 300.

In some embodiments, one or more portions 402 along edge 304 band 106 may be strengthened by an increase in the density of net 300 the transverse and longitudinal bands 104/102, an added layer of net 300, an added layer of polymer or similar or any other strengthening mechanism.

In some embodiments, a net as described herein is composed of a trapeze or a trapezoid structure or structures. In some embodiments, a net as described herein is composed only of trapeze or trapezoid structures. In some embodiments, the transverse band/s and the longitudinal bands form trapeze or trapezoid structures.

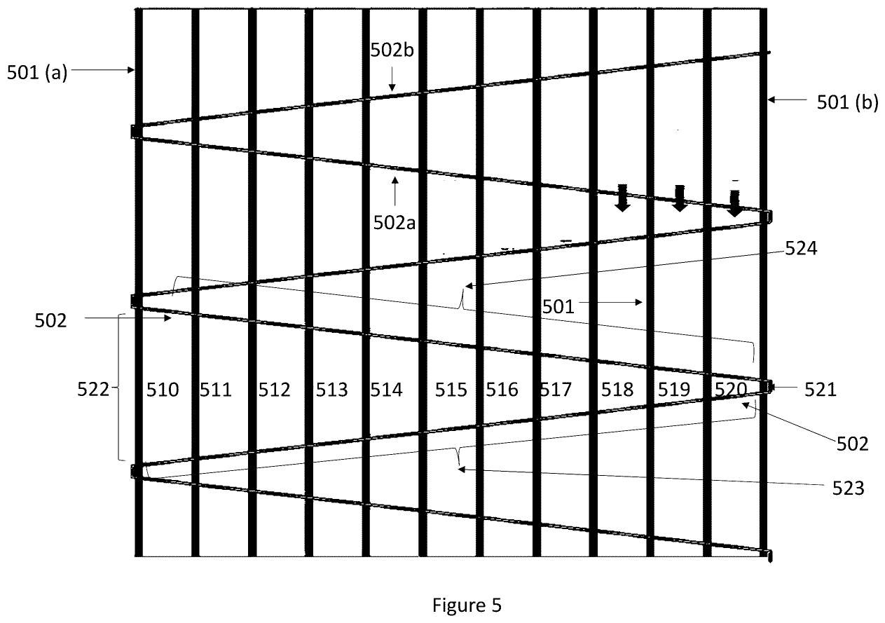

Reference is now made to FIG. 5. In some embodiments, a net as described herein comprises a basic trapezoid structure formed between a first end longitudinal band 501a, a second end longitudinal band 501b, a first adjacent or juxtaposed transverse band 502a and a second adjacent or juxtaposed transverse band 502b, wherein basic trapezoid structure comprises a first base of 0.5-5 cm long 521, a second base of 10-40 cm long 522, a third lateral side 523 and a fourth lateral side 524, each of the third lateral side and the fourth lateral side is 90-140 cm long. In some embodiments, the basic trapezoid structure comprises a first base of 2-4 cm long 521 or 2.5-4.5 cm long 521, a second base of 5-50 cm long (522) or 10-40 cm long 522 or 15-25 cm long 522 or 20-30 cm long 522, a third lateral side 523 and a fourth lateral side 524, each of the third lateral side and the fourth lateral side is 70-140 cm long or 90-140 cm long or 100-130 cm long or 110-125 cm long.

In some embodiments, the basic trapezoid structure is further divided to 8-12 secondary trapezoid structures (elements 510-520). In some embodiments, at least 50% of the secondary trapezoid structures are 6000 to 50000 mm². In some embodiments, at least 50% of the secondary trapezoid structures are 10000 to 40000 mm². In some embodiments, at least 50% of the secondary trapezoid structures are 10000 to 25000 mm². In some embodiments, at least 50% of the secondary trapezoid structures are 12000 to 25000 mm².

In some embodiments, at least 80% of the secondary trapezoid structures are 1000 to 28000 mm². In some embodiments, at least 80% of the secondary trapezoid structures are 2000 to 25000 mm². In some embodiments, at least 80% of the secondary trapezoid structures are 2000 to 22000 mm². In some embodiments, 20-40% of the secondary trapezoid structures are 1000 to 10000 mm². In some embodiments, 20-40% of the secondary trapezoid structures are 2000 to 9000 mm². In some embodiments, 30-40% of the secondary trapezoid structures are 1000 to 10000 mm². In some embodiments, 20-40% of the secondary trapezoid structures are 2000 to 9000 mm². In some embodiments, 10-20% of the secondary trapezoid structures are 500 to 5000 mm². In some embodiments, 15-40% of the secondary trapezoid structures are 1000 to 5000 mm². In some embodiments, 15-40% of the secondary trapezoid structures are 2000 to 5000 mm². In some embodiments, 25-40% of the secondary trapezoid structures are 12000 to 16000 mm². In some embodiments, 35-60% of the secondary trapezoid structures are 12000 to 18000 mm². In some embodiments, the secondary trapezoid structures are 800 to 35000 mm². In some embodiments, the secondary trapezoid structures are 1000 to 30000 mm². In some embodiments, the secondary trapezoid structures are 2000 to 25000 mm².

In one embodiment, the net as described herein is a bale wrap. In one embodiment, provided herein a bale comprising crop (such as but not limited to straw) and the net as described herein. In one embodiment, provided herein a bale comprising crop, wherein the bale is wrapped and/or partially covered by the net as described herein. In one embodiment, the net for covering a bale is 2 to 50 m. In one embodiment, the net for covering a bale is 5 to 30 m. In one embodiment, the net for covering a bale is 5 to 30 m. In one embodiment, the net for covering a bale is 6 to 20 m. In one embodiment, the net for covering a bale is 10 to 18 m. In one embodiment, the net for covering a bale is 15 to 30 m. In one embodiment, the net for covering a bale is 5 to 15 m.

In one embodiment, provided herein a method for wrapping a bale, comprising wrapping the bale with the net as described herein. In one embodiment, provided herein a method for wrapping a bale, comprising wrapping the bale with the net as described herein wherein the bale comprises a crop. In one embodiment, the net as described herein is extremely effective in recycling it after use as a wrapping bale material. In one embodiment, the method utilizing the net promotes recycling of used net. In one embodiment, the method utilizing the net minimizes crop waste upon unwrapping the bale and releasing the net. In one embodiment, the method utilizing the net minimizes crop waste upon unwrapping the net.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

In the description and claims of the application, “m” relates to meter or meters. In the description and claims of the application, “cm” relates to a centimeter or centimeters. In the description and claims of the application, “mm” relates to a millimeter or millimeters.

In the description and claims the terms :net” and “wrap” are interchangeable. In the description and claims the terms trapeze, trapezoid, and trapezoid structure are interchangeable.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A net, comprising:
a plurality of transverse bands; intersecting
a plurality of longitudinal bands;
wherein said net is a rectangular, wherein said net length is at least 100 times longer than said net width;
wherein each longitudinal band of said plurality of longitudinal bands comprises two intermittently adhered films forming channels at discontinuities of adhesion between said films; wherein at an intersection of said longitudinal band and a transverse band, said transverse band is threaded through a channel in said longitudinal band.

2. The net according to claim 1, wherein said net length is from 1800 meters to 6000 meters.

3. The net according to claim 1, wherein the width of said net is 60 to 300 cm.

4. (canceled)

5. (canceled)

6. The net according to claim 1, wherein each film of said two intermittently adhered films has a different width.

7. The net according to claim 1, wherein said net is characterized by (i) a weight/weight ratio of total said longitudinal bands weight to total said transverse band/s weight of 2:1 to 100:1;
(ii) length/length ratio of total said longitudinal bands length to total said transverse band/s length of 3:1 to 1:3, or both (i) and (ii).

8. (canceled)

9. The net according to claim 1, characterized by 6 to 60 longitudinal bands or by 10 to 16 longitudinal bands.

10. The net according to claim 1, wherein said transverse band is 7 to 150 μm thick; and wherein said longitudinal band is 20 to 350 μm thick; wherein the width of said transverse band is 0.5 to 20 mm; and wherein the width of said longitudinal band is 2 to 40 mm.

11. (canceled)

12. (canceled)

13. (canceled)

14. (canceled)

15. The net according to claim 1, comprising: (a) 6 to 60 longitudinal bands per 0.6 to 2.7 m width of said net; or (b) 10 to 16 longitudinal bands per 1 to 1.2 m width of said net.

16. The net according to claim wherein at least one channel of said channels is configured to impede movement of said transverse band through said channel; and wherein at least one channel of said channels comprises: a semi-adhered zone, a non-adhered zone, a friction zone or a combination thereof between said channel and said transverse band/s.

17. (canceled)

18. The net according to claim 1, wherein at least two of a plurality of transverse band/s are threaded through channels of at least two of a plurality of said longitudinal bands and forming four intersections between said longitudinal bands and said transverse band/s.

19. The net according to claim 1, wherein the strength of the adhesion between said transverse band and said films in said intersection is at least 30% weaker than said adhesion between said films.

20. The net according to claim 1, wherein said channel comprises inner surfaces facing each other and wherein the transverse band occupies 3 to 30% of a surface area of said inner surfaces; and wherein the ratio between a surface area of adhered portions of said films to a surface area of said films at said channel is at least 3:1.

21. (canceled)

22. The net according claim 1, wherein at least one of: a position and/or orientation of said transverse band in relation to said longitudinal band at said channel is adjustable; a location of the point of intersection between said longitudinal band and said transverse band is adjustable along the length of at least one of said longitudinal bands and/or said transverse band/s; net adjustability is independent of the elasticity of said transverse band/s and said longitudinal bands.

23. (canceled)

24. (canceled)

25. The net according to claim 1, wherein said transverse band further crosses an edge longitudinal band in a serpentine or zigzag manner.

26. The net according to claim 1, wherein said transverse band/s and said longitudinal bands form trapezoid structures.

27. The net according to claim 1, comprising a basic trapezoid structure formed between a first end longitudinal band, a second end longitudinal band, a first adjacent transverse band and a second adjacent transverse band, wherein said basic trapezoid structure comprises a first base of 0.5-5 cm long, a second base of 10-40 cm long, a third lateral side and a fourth lateral side, each of said third lateral side and said fourth lateral side is 90-140 cm long.

28. The net according to claim 27, wherein said basic trapezoid structure is further divided to 6-20 secondary trapezoid structures; and wherein at least 50% of said secondary trapezoid structures are 10000 to 25000 mm².

29. (canceled)

30. A bale comprising the net according to claim 1, wherein the length of said net is 5 to 30 m.

31. A method of wrapping a bale, comprising wrapping a bale with the net of claim 1, wherein said bale comprises a crop.

32. (canceled)

33. (canceled)
